(19) United States
(12) Patent Application Publication
(10) Pub. No.: US 2003/0013400 A1
(43) Pub. Date: Jan. 16, 2003

(54) Device for opening clamshells such as oysters

(76) Inventor: Michel Auguin, Cazaux (FR)

Correspondence Address: Martin B Pavane, Cohen Pontani Lieberman & Pavane, Suite 1210, 551 Fifth Avenue, New York, NY, 10176, US

(21) Appl. No.: 10/182,945

(22) PCT Filed: Feb. 2, 2001
(86) PCT No.: PCT/FR01/00317

(30) Foreign Application Priority Data
Feb. 2, 2000 (FR) 0001306

(51) Int. Cl. A22C 29/04

(52) U.S. Cl. 452/17

(57) ABSTRACT

The invention relates to a device for opening bivalve shellfish, particularly oysters. It comprises: a base (1) consisting of a longitudinal cradle having a first end (1a) comprising a stop (10) and a second end (1b) comprising first reaction means, it being possible to place, a shellfish (2) between said two ends (1a, 1b) such that it bears against said stop (10); and perforating means (3) comprising a longitudinal blade (4) having a first pointed end and drive means for translational movement of said blade (4), said drive means comprising second reaction means (5a).

The present invention relates to a device for opening bivalve shellfish and particularly, but not exclusively, oysters, venus clams, clams or scallops.

These shellfish are usually opened by professionals: it is a difficult—even dangerous—activity when practised by amateurs.

The steadily increasing popularity of these shellfish has resulted in the appearance of all sorts of devices. These devices make use of a variety of techniques, the most widely used of which involve opening the shellfish sufficiently to enable a knife blade to be inserted in order to cut the muscle joining the two shells.

For this purpose, certain devices pierce one of the shells so that a blade can be inserted to cut the muscle. Other devices make an initial opening of the shellfish on the side, and generally leave shell debris which has to be removed before consumption.

There also exist remarkable machines or installations for professional use only, such as a shock-vacuum apparatus or a hydraulic machine comprising a backstop supporting a ram equipped with a knife (Nicolas patent FR-A-2 542 596). Opening the shellfish via the hinge leaves no debris but the effort required to open it is very great, so that this technique is dangerous especially when the shellfish is not held in position by any independent support. Of the prior art, only those devices that open the shellfish through the hinge will be considered as only these are capable of not producing shell debris and it is more particularly with these that the present invention is concerned. In order to produce the large force necessary to defeat the hinge, the prior-art devices examined usually include some structure for holding the shellfish in position, combined with an opening device.

The Achart patent application 95.14.534 discloses an immobilizing structure consisting of a pair of tongs with two arms. The opening device consisting of an oyster knife is hinged to one of the two arms of the immobilizing structure.

Ricard patent FR-A-2 717 668 discloses a self-locking receptacle on which the shellfish is held. A lever hinged to this receptacle comprises a blade consisting of a spur designed to force open the pointed end of the shellfish.

The Marquis patent FR-A-2 489 127 relates to a device consisting of a base and a projection forming a stop on which the shellfish is positioned and a lever hinged to this base by an adjustment arm. The lever has a wedge designed to penetrate between the edges of the shells and force them apart.

The Riehm patent FR-A-2 432 289 discloses a box forming a support to which are fixed two vertical plates and a spring-loaded pushing device designed to hold the shellfish in position. A lever hinged to the box is equipped with a knife which has a ball joint designed to facilitate its insertion into the two shells.

The Pierson patent FR-A-2 630 316 relates to a device comprising a fixed base with notches to enable the shellfish to be held in position and horizontal slits to guide the blade of a knife which is equipped with a protective guard.

The Chaillou patent FR-A-2 764 177 discloses a device consisting of a hollow body connected to a cage forming a stop designed to hold the shellfish in position, a blade guided inside the said body and worked axially by a two-armed tong-type member that inserts the blade into the pointed end so that the two shells come apart.

The Laventure patents FR-A-463 601 and 2 484 813 relate to a pair of tongs with one arm acting as a stop while the other arm is mobile and fitted with a knife tip which when inserted into the pointed end opens the shellfish by the action of the mobile arm of the tongs.

The Lieutard patent FR-A-2 758 449 discloses a device consisting of a pair of tongs with one arm acting as a stop while the other arm is fitted with a wedge designed to be inserted into the pointed end of the shellfish so as to open it when the mobile arm of the tongs is actuated.

All these devices are often complex and do not give the hoped-for results, which is one of the reasons why none of these devices has displaced any of the others. Besides, they are expensive and require considerable experience in handling them.

The present invention seeks to mitigate the problems and failings of the prior art cited above.

To this end, the device for opening bivalve shellfish, particularly oysters, comprises: a base consisting of a longitudinal cradle having a first end comprising a stop and a second end comprising first reaction means, it being possible to place a shellfish between said two ends such that it bears against said stop; perforating means comprising a longitudinal blade having a first pointed end and drive means for translational movement of said blade, said drive means comprising second reaction means; and said perforating means are able to be engaged in said second end of the cradle, said second reaction means engaging with said first reaction means to prevent translational movement in opposite directions of said drive means and of said cradle, said first pointed end of said blade being placed against said shellfish, which is itself held against said stop, in such a way that operation of the drive means forces said blade into said shellfish, the two valves thereby being at least partly detached from each other.

Thus, the device according to the invention, for opening bivalve shellfish such as oysters comprises in combination a base forming a stop on which the shellfish is held and perforating means, or tongs, fitted with a blade, which bear against the base to open the shells. This device is characterized in that the base forming the stop is formed by a cradle whose first end, or side, holds the shellfish in position and whose second end, or other side, comprises first reaction means acting as a support for second reaction means on the tongs that carry the blade, to allow said blade to be displaced axially and penetrate between the shells at the hinge site when the drive means of the tongs are operated.

In a particularly advantageous manner, said longitudinal cradle comprises two rigid bars, each having a first end and a second end, said bars being held approximately parallel with each other by cross-pieces, the first ends and second ends each being opposite each other, and the middle part of said bars defining a mean plane.

Thus, the base forming the stop is formed by a cradle constructed from two rigid metal circular-section bars held apart by at least two cross-pieces consisting of notched and toothed metal plates designed to hold the shellfish in position and acting as a stop on one of the sides of the cradle when the blade of the tongs is inserted into the hinge of the shellfish so that the shellfish is braced between the cross-pieces and the blade advancing into the hinge when said drive means are operated.

In one particular embodiment of the invention, said first reaction means are formed by the two second ends of said bars, both bent to the same side of said mean plane, toward said first ends of said bars.

Thus, the rigid metal circular-section bars held apart by cross-pieces and providing support, on the other side of the cradle, to the second reaction means, form a rounded backstop against which the tongs, or perforating means, can be positioned, in such a way that the shellfish is braced between the cross-pieces of the blade [sic] penetrating into the hinge when said drive means are operated.

Preferably, said stop is formed by a connecting piece connecting said first ends of said bars and sloping toward said second end.

In this way the end of the backstop comprising the connecting piece formed by an approximately horizontal metal plate not only acts as a cross-piece but also makes it easier to keep the shellfish in position on the cross-pieces, the thumb being placed on the shellfish and the other fingers held against the underside of the metal plate.

In another particular embodiment of the invention, said drive means comprise: guide means for guiding said blade, having a working end and a control end, said first end of the pointed blade being able to project from said working end and the second end of the blade being able to project from said control end; two arms, each of the first ends of which is hinged to either side of said guide means, the arms being able to pivot toward each other and toward said control end; and two links whose first ends pivot on said second end of the blade and whose second ends are each hinged to one arm in such a way that said links form an angle of greater than 90° to said blade, and an angle of less than 180° to each other.

Advantageously, said second reaction means take the form of two projections extending from the respective said first ends of said two arms in opposite directions from each other in such a way as to project from the perimeter of said guide means.

Thus, in accordance with this other feature, the tongs, or perforating means comprising the blade and drive means, consist of two mobile arms comprising on each of these arms a projection by which the arm can react against the rounded backstop of the base.

The arms of the tongs are preferably each inserted and pivoted about an axis where the projections are located in the guide means, or cover, which serves as a guide and stop for the blade.

Thus, the blade, guided inside the cover, comprises the two links hinged to each side of the blade and to each of the tong arms in such a way that when the arms are brought together, said blade moves axially and, when inserted into the hinge of the shellfish, penetrates into it with a wedge action and causes the shellfish to open.

In accordance with an advantageous feature, said guide means comprise a stop on each side to limit the opening of said two arms. In this way the cover comprises on each side of the blade a stop that limits the opening of the tong arms so that the blade projects from it and the blade can be inserted into the hinge of the shellfish.

Preferably, said perforating means comprise spring means capable of pushing the two arms apart. In accordance with a variant, a spring acting on the links and on the end of the cover, or guide means, keeps the arms of the tongs open.

Also, with particular advantage, all component parts of the device are metallic and made of food-grade stainless steel.

The device according to the invention thus uses a cradle to position the shellfish and hold it in position. This cradle also acts as a support for a pair of tongs equipped with a blade.

Before the shellfish is positioned on the cradle, the blade of the tongs is inserted into the hinge of the shellfish. The shellfish is positioned on the cradle, the projections of the arms of the tongs resting against the backstop of the cradle. As the arms of the tongs are closed, the blade, which forms a wedge, penetrates into the shellfish and severs the hinge. It is then a simple matter to take the shellfish in one hand and with the other to keep the two arms of the tongs closed and use the blade to cut through the muscle holding the two shells together. The shellfish is thus opened via the hinge and no debris is left inside. The effort required is relatively small. There is no risk of injury.

The device according to the invention satisfactorily answers its intended purposes.

Other features and advantages will become clearer on a reading of the following description of an embodiment of the device according to the invention given by way of non-restrictive illustration with reference to the accompanying drawings, in which:

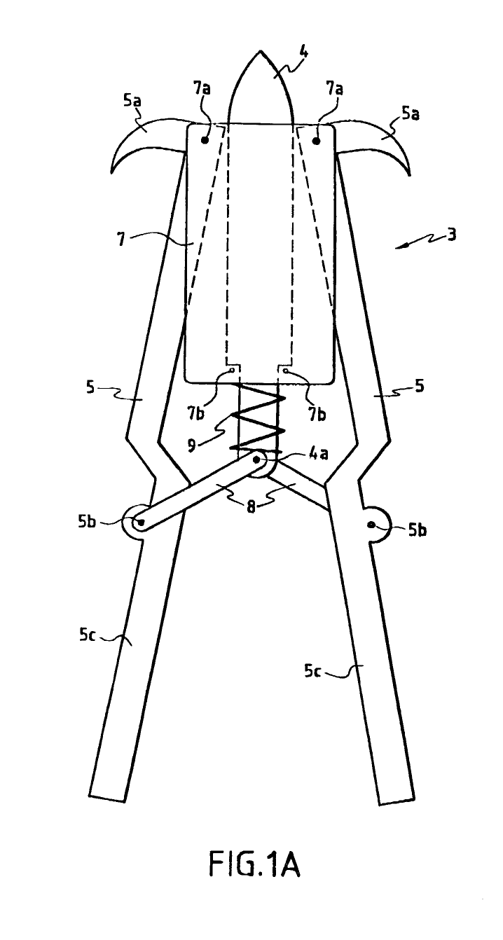

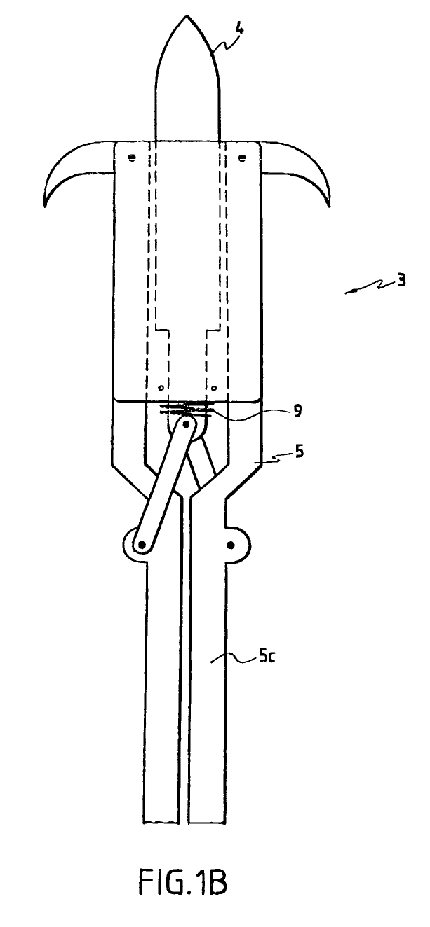

FIG. 1A is a diagrammatic plan view of the tongs, with the arms open,

FIG. 1B shows the tongs with the arms closed,

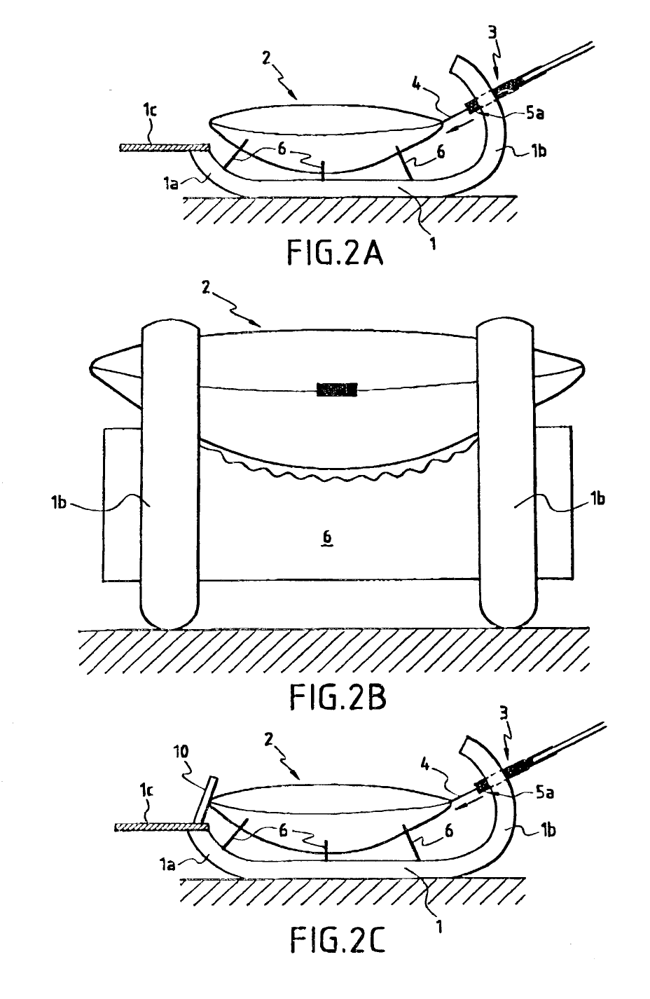

FIG. 2A is a diagrammatic side view of the device according to the invention;

FIG. 2B is a diagrammatic front view of the shellfish held on the base without the tongs; and

FIG. 2C is a diagrammatic side view of the device according to the invention in one particular embodiment.

FIG. 1A is a diagrammatic plan view showing the tongs 3 in the [lacuna] 5 open position. Each arm has at one end a lower part 5c or handle and at the other end a projection 5a to enable the tongs to be held against the cradle in which the shellfish is supported. The arms are connected to each other by a cover 7 consisting of two plates holding the arms from above and beneath, while the arms each pivot about an axis 7a which also connects the two plates of the cover 7. A blade 4 slides between the cover plates. The displacing of the blade is brought about by two links 8 that pivot on a common axis 4a on the blade and on an axis 5b on each arm 5. A spring 9 is placed between the cover 7 and the links 8 at the location of their common axis 4a. Rear stops 7b limit the movement of the blade 4 and the opening of the arms 5.

FIG. 1B shows the tongs 3 with arms 5 closed and spring 9 compressed. The lower parts 5c of the arms are side by side. Although not shown, a covering inserts [sic] the lower parts 5c of the arms in the manner of a handle of a knife to facilitate operation of the arms 5. The blade 4 is in the forward position.

The amplitude of the movement is of the order of 25 to 30 mm, which is sufficient to sever the hinge. When opened out, the blade measures some 60 mm, connecting the two shells [sic], enabling the muscle to be cut.

A diagrammatic side view 2A shows the device according to the invention consisting of the cradle forming the base 1 on which the shellfish 2 is positioned and held. The shellfish is supported by two or three cross-pieces 6 that keep the two metal circular-section bars of the cradle forming the base 1 apart. An approximately horizontal plate 1c is fixed to a first end 1a of the cradle, on the ends of the bars, acting both as a cross-piece and making it easier to secure the shellfish on the cross-pieces 6. The thumb exerts pressure on the shellfish, and for this purpose the other fingers are held against the underside of this horizontal plate 1c.

The tongs 3 profile view shows the total thickness of the tongs consisting of three successive thicknesses of 2 to 3 mm of food-grade stainless steel, the lower plate of the cover 7 with links [sic] 8, the arms 5 fitted with the blade 4, and the lower [sic] plate of the cover 7 with links [sic] 8.

These tongs 3 are inclined at about 30° from the horizontal plane on which the base 1 is resting. This position facilitates penetration of the blade into the hinge.

Moreover, this hinge is not exactly on the approximate axis separating the shellfish into two parts. It is usually, especially in the case of oysters, offset to the left, when the device is seen in plan view. Consequently the shellfish is opened more easily by inclining the tongs at about 30° and displacing the shellfish slightly to the right. In this position the projections 5a pressing against the backstop 1b of the base enable the shellfish to be braced between the blade 4 and the cross-pieces 6. In this way the effort required to drive the blade into the shellfish hinge is reduced.

FIG. 2B shows a front view from the backstop side of the shellfish held on the base. The shellfish rests on the toothed and notched cross-pieces 6 which imitate the shape of the shellfish so as to absorb the force exerted by the blade when the arms 5 of the tongs 3 are squeezed.

The device according to the invention, consisting of the combination of a base 1 and a pair of tongs 3 satisfactorily answers the initial objectives: ease of use, safety and inexpensive.

FIG. 2C illustrates a particular embodiment of the invention in which the cradle forming the base 1 has in its first end la a stop 10 formed by a connecting piece connecting said first ends of said bars and inclined toward said second end. In this way the shellfish 2 is held against the stop 10 when the blade 4 is driven by the perforating means, or tongs 3 against the join line of the shellfish 2.

In addition, it will be realized that the position of the blade 4 can be adapted to the shape of the shellfish because of the curved shape of the second end of the cradle. Also, because the second reaction means react against the second curved end, they are easily removable from the cradle as soon as the force applied to the drive means is discontinued.

Any modifications capable of being made by those skilled in the art to the device described above which do not alter the original arrangements and are merely simple technical equivalents also fall within the scope of the present invention.

1. Device for opening bivalve shellfish, particularly oysters, said device comprising a longitudinal base (1) having a first end (1a) comprising a stop (10) and a second end (1b) comprising first reaction means, it being possible to place a shellfish between said two ends and perforating means (3) comprising a longitudinal blade (4) whose first end forms a point and drive means for translational movement of said blade, characterized in that said drive means of said blade (4) comprise:
guide means (7) for guiding said blade (4), having a working end and a control end, said first end of the pointed blade being able to project from said working end and the second end of the blade being able to project from said control end;
two arms (5c), each of the first ends of which is hinged to either side of said guide means, the arms being able to pivot toward each other and toward said control end;
two links (8) whose first ends pivot on said second end of the blade (4a) and whose second ends are each hinged to one arm in such a way that said links (8) form an angle of greater than 90° to said blade (4), and an angle of less than 180° to each other;
second reaction means (5a);
and in that said second reaction means (5a) are connected to said first reaction means (1b) to prevent translational movement in opposite directions of said drive means and of said base (1), said first pointed end of said blade (4) being placed against said shellfish (2), which is itself held against said stop (10), in such a way that operation of the drive means forces said blade (4) into said shellfish (2), the two valves thereby being at least partly detached from each other.

2. Device for opening bivalve shellfish according to claim 1, characterized in that said longitudinal base (1) forming a cradle comprises two rigid bars, each having a first end and a second end, said bars being held approximately parallel with each other by cross-pieces, the first ends and second ends each being opposite each other, and the middle part of said bars defining a mean plane.

3. Device for opening bivalve shellfish according to claim 2, characterized in that said first reaction means (1b) are formed by the two second ends of said bars, both bent to the same side of said mean plane, toward said first ends of said bars.

4. Device for opening bivalve shellfish according to claim 2 or 3, characterized in that said stop (10) is formed by a connecting piece connecting said first ends of said bars and sloping toward said second end (1b).

5. Device for opening bivalve shellfish according to any one of claims 1-4, characterized in that said second reaction means (5a) take the form of two projections extending from the respective said first ends of said two arms (5c) in opposite directions from each other in such a way as to project from the perimeter of said guide means (7).

6. Device for opening bivalve shellfish according to any one of claims 1-5, characterized in that said guide means (7) comprise a stop on each side to limit the opening of said two arms.

7. Device for opening bivalve shellfish according to any one of claims 1-6, characterized in that said perforating means (3) comprise spring means (9) capable of pushing the two arms (5c) apart.

8. Device for opening bivalve shellfish according to any one of claims 1-7, characterized in that all component parts of the device are metallic and made of food-grade stainless steel.
